(19) United States
(12) Patent Application Publication
(10) Pub. No.: US 2005/0257586 A1
(43) Pub. Date: Nov. 24, 2005

(54) Method of sustaining plant growth in hazardous substrates, limiting the mobility of substrate contaminants, and beneficiation of normal soils

(76) Inventors: Stephen R. Dunn, Calgary, CA (US); Peter Leggo, Linton (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/021,604

(22) Filed: Dec. 23, 2004

(30) Foreign Application Priority Data
Dec. 23, 2003 (CA) 2,452,701

(51) Int. Cl. C05F 11/08

(52) U.S. Cl. 71/15

(57) ABSTRACT

A method of sustaining plant growth in toxic substrates polluted with heavy metal elements, characterized in that it comprises amendment and remediation of the toxic substrates with a bio-organic-zeolitic mixture. Vegetation, such as hyperaccumulator plants or native plants and grasses for in situ remediation, will now grow, and the mobility of the subsurface contaminants will be inhibited. The method can also be used as a fertilizer and for beneficiation of normal, uncontaminated soils.

Activities in the Industrial Age have resulted in the deposit of high levels of many metals in certain sites, to the point that human life is seriously threatened. Metal-production activities, such as mining or smelting, as well as the ubiquitous use of metals, have created many sites where toxic metals have become concentrated in soils.

In recent years, efforts have been made to develop phyto-remediation methods, e.g., the use of metal-accumulating plants called metallophytes to remove contaminating metals from sites. It has been known for some time that many plant species will concentrate certain metals in their leaves, stems and roots to a varying degree.

For heavy metals, two different types of phyto-remediation methods can be distinguished: rhizofiltration, by concentration of heavy metals in plant roots; photo-stabilization, the roots of the plants limiting heavy metals' availability and limiting mobility of said metals into the groundwater.

More than 400 phyto-remediators are known, most of them absorbing Nickel. The most rarely absorbed heavy metals include Manganese, Cadmium and Lead.

Various metallophytes have been tested, such as Brassicaceae (Thlaspi brachypetal, Thlaspi ochroleucum, Thlaspi caerulescens, Thlaspi rotundifolium, Cardaminopsis halleri), Caroyphyllaceae (Minuartia verna, Polycarpea synandra), Fabaceae (Astragalus Pectinatus, Astragalus bisculatus), Myriophyllium verticullatum, Pshychotrai douerreer, Viola calaminaria.

Document U.S. Pat. No. 6,917,117 relates to a method by which hyperaccumulation of metals in plant shoots such as Brassicaceae (e.g., Brassica, Sinapsis, Thlaspi, Alyssum, Eruca) is induced by exposure to phytotoxic inducing agents such as chelating agents (e.g., Roundup®) and high concentrations of heavy metals. The exposure to the inducing agent is made after a period of plant growth, as metal accumulation into plant shoots has dramatic effects on plant growth. The use of phytotoxic inducing agents as described in document U.S. Pat. No. 5,917,117 is non-ecological and potentially dangerous for the operator.

Document U.S. Pat. No. 5,711,784 discloses a method of extracting nickel, cobalt and other metals including the platinum palladium metal families from soil by phytomining. The conditions include 1) lowering the soil pH by addition of sulphur and use of ammonium N fertilizers, 2) maintaining low Ca in the soil by acidification of the soil with sulphur or sulphuric acid, and 3) applying chelating agents to the soil, such as NTA.

The method in document U.S. Pat. No. 5,711,784 is complicated and non-ecological. Document U.S. Pat. No. 5,927,005 relates to a method of removing heavy metals from soil using creosote plants (Lacrea tridentate). Again, to increase the rate of metal uptake in the plants, it is proposed to increase the acidity or to add chelators to the soil in which the creosote bushes are growing.

Other phyto-remediation techniques are described in documents WO-A-00/28093, WO-A-00/31308, WO-A-98/59080, WO-A-94/01357, EP-A-0 911 387, JP-A-57.000.190, DE-A-41.00758, DE-A-39.21336, U.S. Pat. No. 5,100,455, U.S. Pat. No. 5,320,663, U.S. Pat. No. 5,364,451, U.S. Pat. No. 5,785,735, U.S. Pat. No. 5,809,693, U.S. Pat. No. 5,853,576, U.S. Pat. No. 5,928,406, U.S. Pat. No. 5,944,872, U.S. Pat. No. 6,117,462.

Despite increasing interest and research, several problems associated with phyto-remediation remain. For example, some metals in contaminated areas may be hardly reached via phyto-remediation because they lie beneath the rhizosphere, many of the known metal-accumulating plants being simply too small to accumulate large quantities of metals. Additionally, many of the plants thus far identified as useful in phyto-remediation are from tropical regions.

One object of the invention is to provide means of preventing surface erosion, especially for toxic substances polluted with heavy metal elements.

Another object of the invention is to provide means of promoting growth of metallophytes and other plants on toxic ground polluted by the presence of heavy metal elements.

Another object of the invention is to provide the above-mentioned means, said means being ecological and less expensive than most known bio-remediation methods.

Another object of the invention is to inhibit the mobility of subsurface contaminants.

Another object of the invention is that in addition to hyperaccumulator plants, to use native grasses and plants.

According to the invention, there is provided a method of sustaining plant growth in toxic substrates polluted with heavy metal elements, characterized in that it comprises amendment of the toxic substrates with a bio-organic-zeolitic mixture.

The heavy metal element(s) can be the typical ones, such as Zinc, Copper, Lead, Cadmium, Arsenic, Mercury, the bio-organic-zeolitic mixture being added to the said polluted substrate between 5% and 60%.

The method of the present invention can be used to sustain the growth of various plants, especially plant root growth in toxic substrates polluted with heavy metal elements.

Normally, owing to the lack of available nitrogen and other essential nutrient elements, ground containing high levels of toxic metals would not sustain plant growth to a level that will prevent surface erosion. By amending the ground with the bio-organic-zeolitic fertilizer, this condition can be overcome by growing plants with very dense root systems.

The method of the present invention can be manipulated to vary the shoot-to-root ratio of the plant species used. In this respect, plants which concentrate heavy metals such as Zn, Cd and Cu in their shoots can be grown successfully and cropped to remove the metals from the rhizosphere.

This invention has further proved that there is no uptake of subsurface contaminants into the leaf structures.

The method of the present invention will enable the metal-enriched plant tissue, on ashing, to be reduced to a small volume which can be disposed of easily by mixing with zeolite-amended Portland cement and used in the production of concretes that are known to have high compressive strengths.

More precisely, after harvesting and ashing the plant, the heavy metal cations contained in the ash may be put into aqueous solution and ion-exchanged into a zeolitic tuff. The resulting zeolitic material can be dried and used to produce blended cements which have improved compressive strength and are also known to reduce the expansion caused by alkali-aggregate reactions.

It is known that natural zeolite minerals can be used as biological fertilizer (see for instance JP-A-10210855, JP-A-4197110, EP-A-444392, U.S. Pat. No. 5,082,488, U.S. Pat. No. 5,451,242, U.S. Pat. No. 5,900,387, RU-A-2 121 777, RU-A-2 132 122, RU-A-2 137 340). The preparation of an organic fertilizer incorporating zeolitic tuff is described in document U.S. Pat. No. 4,559,073, the inclusion of the zeolitic component being claimed to lower the water content of the mixture to allow effective aerobic fermentation.

Document U.S. Pat. No. 5,106,405 discloses the property of ion-exchanging ammonium ions that, via soil microbial reactions, would supply available nitrogen to plants growing in a substrate amended with a bio-fertilizer containing a zeolitic component.

The inventor has discovered that natural zeolite materials could be used to prepare a biological fertilizer which can be applied to ground contaminated with heavy metal cations to enable the sustainable growth of plants and to control the development of shoot-to-root in such a way that plant morphology can be adjusted to either maximize soil retention by dense root growth or increase the foliage uptake of toxic heavy metal ions.

If untreated, such ground will not support vegetation and becomes subject to surface erosion by wind and rain. Toxic material transported by these agents into local drainage patterns is thus isolated and therefore uncontrollable.

Specific implementation of the invention will now be described, by way of the invention as claimed herein. Any variations in the exemplified compositions and methods which occur to the man skilled in the art are intended to fall within the scope of the present invention.

### EXAMPLE

A clay-rich toxic soil containing: 2.87% Organic matter, 1.1% Calcium carbonate, 2.2% total Iron, 28.9 mg.kg-1 Zinc, 670 mg.kg-1 Lead, 12.2% mg.kg-1 Cadmium and 18.9 mg.kg-1 Arsenic has been amended with 16.7% bio-organic-zeolitic fertilizer.

Bio-organic-zeolitic fertilizer is prepared as follows:

Animal waste, e.g., chicken manure, is composted together with crushed zeolitic tuff containing the zeolite Ca, K, Clinoptilolite in a ratio of 1:2 (by volume) i.e., tuff to manure. The materials are mixed together with enough water to make the pile damp and choppen straw is added. Air is forced through the pile from (a) perforated plastic pipe(s) laid inside the pile during construction and the reaction is carried out under cover. This could prevent saturation of the pile with rain water.

The pile reaches 50-70° C. and then the temperature drops to ambient, at which stage the composted material is dry, friable, odourless and ready for use as an bio-organic-zeolitic fertilizer.

Spring Wheat (Triticum aestivum L., cv. Red Fife) was sown in two-kilogram substrates. Wheat grown in the untreated soil was used for comparison. The plants were grown in 255 mm-diameter pots, replicated four times, under ordinary lighting conditions in a greenhouse. Watering, with de-ionized water, was by weight to field capacity (180 ml per 2-kg substrate) and the pots were placed in shallow trays to retain leachate. Watering, generally on a daily basis, prevented the plants from drying out and any water running from the pots was returned to the substrate surface with little loss. Plants were harvested on a regular basis each month and the shoot weights were recorded after drying to constant weight at 70° C.

One month after germination the substrates were leached with 400 ml of de-ionized water (pH=8.4) and, after removal of fine colloidal particles, were analyzed chemically. Two further leachate collections were made at monthly intervals over a three-month growth period.

Leachate chemistry at the third harvest

| | | | |
|---|---|---|---|
| Toxic substrate | N conc | 0.23 | mg/l |
| Amended substrate | N conc | 178.00 | mg/l |
| Toxic substrate | K conc | 17.38 | mg/l |
| Amended substrate | K conc | 66.70 | mg/l |
| Toxic substrate | Ca conc | 20.40 | mg/l |
| Amended substrate | Ca conc | 253.00 | mg/l |
| Toxic substrate | Mg conc | 2.69 | mg/l |
| Amended substrate | Mg conc | 27.10 | mg/l |
| Toxic substrate | pH 7.8 | E.C. 149 | μS/cm |
| Amended substrate | pH 7.2 | E.C. 2077 | μS/cm |

These results demonstrate the degree of mobilization of major cations in the amended soil solution.

In the case of the metal trace elements, a general decrease is seen in the leachates between high concentrations in the toxic substrates and low concentrations in the amended substrates. An example is shown below for Zinc.

| | |
|---|---|
| Toxic substrate: | Zn conc 0.65 mg/l |
| Amended substrate: | Zn conc 0.65 mg/l |

Following the analysis of the leachates, the chemical analyses of the plant shoots express the way in which nutrient and trace metal elements are taken up from the respective substrates.

Plant shoot chemistry at the third harvest

| | |
|---|---|
| Amended Substrate | Toxic Substrate |

| | | | | |
|---|---|---|---|---|
| N conc | 2.19 | wt % | 1.16 | wt % |
| K conc | 35.33 | mg/g | 18.20 | mg/g |
| Ca conc | 5.82 | mg/g | 2.82 | mg/g |
| Mg conc | 1.24 | mg/g | 0.85 | mg/g |
| Zn conc | 124 | μg/g | 67 | μg/g |
| Pb conc | 5 | μg/g | 3 | μg/g |
| Cu conc | 17 | μg/g | 5 | μg/g |

The plant shoot chemistry can now be compared to the established nutrient range for Spring Wheat.

| | % dry wt | | | | | μg/g | |
|---|---|---|---|---|---|---|---|
| | N | P | K | Ca | Mg | Zn | Cu |
| Adequate range | 3.0-4.5 | 0.3-0.5 | 2.9-3.8 | 0.4-1.0 | 0.15-0.3 | 20-70 | 5-10 |
| Toxic substrate | 1.16 | 0.5 | 1.80 | 0.3 | 0.10 | 67 | 5 |
| Amended substrate | 2.19 | 0.3 | 3.50 | 0.6 | 0.12 | 124 | 17 |

Shoot dry weight recorded at monthly harvests

| | Dry weight (g/plant) |
|---|---|
| 1st harvest | |
| Toxic substrate: | 0.26 |
| Amended substrate: | 0.89 |
| 2nd harvest | |
| Toxic substrate: | 0.52 |
| Amended substrate: | 5.36 |
| 3rd harvest | |
| Toxic substrate: | 1.03 |
| Amended substrate: | 6.77 |

Comments on Example

The type of bio-organic-zeolitic fertilizer of the present invention can be adapted to grow plants with a dense root system on toxic soils that cannot normally supply sufficient plant nutrients to support such growth. This is achieved by microbiological means only, as no inorganic mineral salts have been added.

It can be seen from the chemistry of the plant shoots that when the available nitrogen in the substrate is some 35% below the adequate range, a dense root system (in the case of Spring Wheat) is formed. As the percentage of bio-organic-zeolitic material added to the toxic soil can be altered, the concentration of available nitrogen can be adjusted to suit the plant species concerned. If maximum shoot growth is required, then the percentage of bio-organic-zeolitic material can be adjusted upwards to put the nitrogen concentration into the adequate range. This would be desired if maximum plant uptake was required in order to remove heavy metals from the rhizosphere.

The trace element concentrations of Zinc and Copper in the plant shoots show that the mobilization of cations in the soil solution, due to the microbial activity of the bio-organic-zeolitic material, make these elements available to the plant. On harvesting, the soil will be partially depleted in these elements and in time the rhizosphere will become less polluted. The volume of plant material after harvest can be greatly reduced by ashing and can be safely stored or possibly recycled.

As it is known that the addition of finely crushed zeolitic tuff to Portland cement improves its physical and chemical properties, the suggestion is made that heavy metal cations remaining in the plant ash could be exchanged into zeolitic tuff which is afterwards used for such a purpose.

Possible Explanation

A proposed explanation of the above-mentioned results is given below, the detailed mechanism still being the subject of research by the inventor. During bio-organic-zeolitic fertilizer preparation, choppen straw likely provides a source of carbon to support bacterial growth. Ammonifying bacteria (as typified by Clostridium and Penicillium) acting on the organic material decompose proteins, amino sugars and nucleic acids to ammonia. The ammonia in the cationic form NH4+ is ion-exchanged into the zeolite where it is held, loosely bound, within the pore space of the crystal lattice. The bacterial activity causes the increase of temperature up to 50-70° C., the completion of the reaction being reached as the temperature drops to ambient.

On addition of the fertilizer to a plant substrate, the NH4+ ions held in the zeolite pore space diffuse at an exponential rate into the substrate. Nitrifying bacteria present in the bio-organic-zeolitic component use the diffusing NH4+ to produce a large source of nitrate that is used in plant growth. As a consequence of the bacterial reactions, free hydrogen ions (protons) are liberated and mobilize the soil solution, causing the dissociation of metal cations present in the substrate.

The inventor has demonstrated how the bio-organic-zeolitic fertilizer can be used with soils polluted with heavy metals such as Zinc, Cadmium, Copper and Lead. The inventor has now found that when 16-17% bio-organic-zeolitic fertilizer is added to such soils, similar effects occur which greatly increase nitrate concentration and mobilize metal cations in the soil solution.

Amending a toxic soil in this way slightly lowers the pH of the soil solution but increases its electrical conductivity by an order of magnitude. At the level of amendment quoted (16-17%), twice the amount of available nitrogen present in the toxic soil is provided. This increase is 35% below the adequate range for Spring Wheat (Triticum aestivum L., cv. Red Fife) and has the effect of maximizing the root/shoot ratio. In this way a dense root system can be developed. By increasing the amount of bio-organic-zeolitic fertilizer added to the soil, the root-to-shoot ratio can be decreases, in which case shoot growth is favoured.

Cation mobilization in the soil solution provides the growing plant with nutrients such as Potassium, Calcium, Magnesium and Zinc, and the plant's requirement acts to buffer the system against concentration of these elements and diffusion from the rhizosphere. By increasing the level of plant nutrients in this way a healthy plant can be grown and sustained on toxic soils polluted with heavy metals. In the case of Zinc and Copper, the inventor has observed that these elements are taken up by the plant at a rate that can be tolerated, and the damage occurring in the same plants grown in the toxic soil is not seen. This property can be used to remove heavy metal elements from the rhizosphere by harvesting the plant. The plant material can be greatly reduced in volume by ashing without loss of the heavy metals and incorporated in a mixture of Portland cement and finely crushed zeolitic tuff. In this way, concrete of high compressive strength and low alkali reactivity can be made and used to store the heavy metal elements.

Land contaminated, poisoned and polluted by industrial and mining operations is a terrible problem. These toxic sites are an extreme danger to the environment and to the health of people who live nearby.

These toxic lands, upon which only very sparse vegetation can grow (if it can grow at all), have erosion rates 100 to 1000 times higher than lands covered by full-rooted, permanent vegetation.

It is vital to fully realize that once these poisonous metals (lead, mercury, cadmium, zinc, copper, nickel, etc.) are blown as a fine dust by the wind, they are impossible to control. The result is contamination and pollution of the air we breathe, the water we drink (and eventually the ground water), and inevitably the food chain itself. It is, therefore, crucial to develop a method which treats the problem in situ.

A very important part of the invention is to treat toxic substrates polluted with heavy metal elements in situ. Contaminated surface sites have erosion rates which are 100 to 1000 times higher than on land covered by permanent vegetation. Native grasses and plants planted with our bio-organic-zeolitic mixture increase the root growth significantly and increase the retention of soil particles and heavy metals, thus they will remain in situ.

Acidic soils present a particularly difficult problem to overcome in the revegetation of soils contaminated with mine wastes. This is often due to the continual oxidation of sulphide minerals, generating sulphuric acid which lowers the pH of the soil solution. Nitrification rates begin to decrease below pH 6.0 and become negligible below 4.5. The consequence is that it becomes impossible to grow plants in soils with pH values below 3. Recent work has shown that the zeolitic component of the bio-fertilizer acts to increase soil pH to a level at which nitrifying bacteria can survive and multiply.

Statement Work on Ryegrass (Lolium perenne L.) has shown that amendment of the plant substrate with the zeolite bio-fertilizer will enhance plant growth in a similar way to that seen with Spring Wheat (Triticum aestivum L., cv. Paragon).

Dense root systems can be sustained in soils polluted with heavy metals. The contaminated substrate used was identical to that in the spring wheat programme as described in the above patent.

In the ryegrass programme, unammoniated zeolitite (i.e., zeolitized volcanic tuff containing the zeolite mineral clinoptilolite) was added in varying proportions to the initial amended substrate containing 16-17 vol. % bio-organic-zeolitic fertilizer (zeolite bio-fertilizer).

The exchangeable cations in the clinoptilolite used are Calcium and Potassium. Zeolite minerals with appreciable quantities (>ca2 Wt %) are undesirable as reactions in the plant substrate increase the sodium availability which can cause depression in growth. The typical formula of the clinoptilolite used is (K_{1.9} Ca_{1.3} Na_{0.4} Mg_{0.1}) Al_{6.1} Si₂₉₉ O₇₂ 23.1 H₂O.

It was found that the relationship between shoot dry weight and weight % excess zeolitite defined the (cut-off) limit of growth enhancement above which continued addition of zeolitite diminished plant growth.

This effect was found to vary according to plant density. A low-density group (25 plants/pot) had a higher cut-off limit than a high-density group (ca. 600 plants/pot).

The low-density plants also showed greater growth enhancement than the high-density group.

Analytical Data: Shoot Dry Weights

(i) Low-density group harvested at four months.

| Plant substrate | | Shoot weight (g) |
|---|---|---|
| Gp. 1 | Toxic substrate | 7.38 |
| Gp. 2 | Amended substrate (16-17) vol % | 31.46 |
| | bio-organic-zeolitic fertilizer | |
| Gp. 3 | Ditto + 75 wt % unammoniated zeolitite | 32.73 |
| Gp. 4 | Ditto + 150 wt % unammoniated zeolitite | 33.36 |
| Gp. 5 | Ditto + 225 wt % unammoniated zeolitite | 33.98 |
| Gp. 6 | Ditto + 300 wt % unammoniated zeolitite | 28.87 |

(ii) High-density group harvested at five months.

| Plant substrate | | Shoot weight (g) |
|---|---|---|
| Gp. 1 | Toxic substrate | 6.76 |
| Gp. 2 | Amended substrate (16-17) vol % | 25.83 |
| | bio-organic-zeolitic fertilizer | |
| Gp. 3 | Ditto + 75 wt % unammoniated zeolitite | 36.49 |
| Gp. 4 | Ditto + 150 wt % unammoniated zeolitite | 25.46 |
| Gp. 5 | Ditto + 225 wt % unammoniated zeolitite | 25.10 |
| Gp. 6 | Ditto + 300 wt % unammoniated zeolitite | 24.51 |

Statement

The root systems in the low-density group show a decline in root mass above an excess addition of 150 wt % unammoniated zeolitite.

As in the case of the shoot mass, a distinct cut-off is seen in root growth. In the present case, working with heavy metals in the specified range in neutral to slightly alkaline conditions, no advantage is gained in increasing the excess zeolitite above 150 wt %. Shoot growth is maximized at 225 w/o excess zeolitite. This again demonstrates that the bio-fertilizer can be formulated to maximize either shoot or root growth.

In order to formulate the bio-fertilizer for these effects, it will be necessary to conduct initial laboratory trials as the biological factors (i.e., remedial plant species and density), bacterial population, soil properties, heavy metal species and concentrations will vary independently at specific sites.

Analytical Data: Root Dry Weights

(i) Low-density Group Harvested at Five Months.

| Plant substrate | | Root weight (g) |
|---|---|---|
| Gp. 1 | Toxic substrate | 3.45 |
| Gp. 2 | Amended substrate (16-17) vol % | 6.53 |
| | bio-organic-zeolitic fertilizer | |
| Gp. 3 | Ditto + 75 wt % unammoniated zeolitite | 8.43 |
| Gp. 4 | Ditto + 150 wt % unammoniated zeolitite | 11.80 |
| Gp. 5 | Ditto + 225 wt % unammoniated zeolitite | 11.67 |
| Gp. 6 | Ditto + 300 wt % unammoniated zeolitite | 7.44 |

Statement

Harvested plant shoots in the high-density group were analyzed for trace concentrations of Zinc, Copper and Lead. By relating the trace metal chemistry to the shoot dry weight of the amended groups it was found that the cut-off limit corresponded to a concentration of 138 μg.g₋₁ Zinc. Above this value, shoot dry weight dropped dramatically.

Analytical data: Trace Metal Chemistry in Shoots

| | | μg · g | | |
|---|---|---|---|---|
| Plant substrate | | Zn | Pb | Cu |
| Gp. 1 | Toxic substrate | 74.2 | 6.7 | 16.1 |
| Gp. 2 | Amended substrate (16-17) vol % | 106.7 | 6.8 | 22.2 |
| | bio-organic-zeolitic fertilizer | | | |
| Gp. 3 | Ditto + 75 wt % unammoniated zeolitite | 138.1 | 6.1 | 26.0 |
| Gp. 4 | Ditto + 150 wt % unammoniated zeolitite | 140.6 | 7.6 | 24.6 |
| Gp. 5 | Ditto + 225 wt % unammoniated zeolitite | 163.4 | 6.5 | 22.9 |
| Gp. 6 | Ditto + 300 wt % unammoniated zeolitite | 170.0 | 9.4 | 23.0 |

Statement

A large increase in the electrical conductivity is seen to occur between leachate solutions from the toxic and amended substrates; which is characteristic of soils amended with the bio-fertilizer.

This reaction is taken to infer that the nitrifying bacteria are boosted by addition of the bio-fertilizer.

A relationship is seen between shoot total nitrogen and excess zeolitite. The data shows that a fluctuation occurs between the amended substrates throughout the range of excess zeolitite.

This behaviour is not clearly understood but is apparently a function of the bacterial composition developed in the amended substrates.

| | | |
|---|---|---|
| Plant | E.C. | Shoot total nitrogen (wt %) |

| substrate | (μSiemens/cm) | (Low density) | (High density) |
|---|---|---|---|
| Gp. 1 | 119 | 0.74 | 0.98 |
| Gp. 2 | 472 | 1.48 | 1.54 |
| Gp. 3 | 285 | 1.17 | 1.39 |
| Gp. 4 | 323 | 1.37 | 1.47 |
| Gp. 5 | 189 | 1.09 | 1.38 |
| Gp. 6 | 488 | 1.13 | 1.32 |

Comments on Results

The plant weight results demonstrate the performance of ryegrass grown in heavy metal-polluted soils of neutral to slightly alkaline pH that has been amended with bio-organic-zeolitic fertilizer.

Very large increases in plant growth occur in the amended substrates. The increase obtained in root growth is particularly important for the retention of soil particles contaminated by heavy metal residues. However, limits are reached in the addition of unammoniated zeolitite above which the plants suffer deleterious effects.

As the zinc concentrations found in the shoots correlate to the behaviour of the shoot dry weights, this element is thought to cause a major phytotoxic effect which is limiting growth. Although the detailed interactions between the bio-fertilizer, soil chemistry and bacterial population are still under investigation, it is clear that by studying the effect of varying the concentration of the unammoniated zeolitite the bio-fertilizer can be formulated to provide maximum growth enhancement.

Continuing study by the inventor, Peter J. Leggo, has revealed that a substantial additional growth enhancement can be achieved by increasing the content of unammoniated zeolitic tuff in the zeolite bio-fertilizer amended substrate.

In the case of Spring Wheat (Triticum aestivum L., cv. Red Fife), the additional increase in shoot dry weight relative to plants grown in a garden soil substrate amended with 16.7 wt % bio-organic-zeolitic fertilizer was found to be 48.8 wt %. A similar relative increase of 38.0 wt % was found to also occur in the root system. This effect was produced by increasing the unammoniated zeolite tuff content of the substrate by 65.0 wt %.

A similar but more diverse effect was seen in Ryegrass (Lolium perenne L.) grown in metal-contaminated soil. In this case, shoot dry weight was seen to increase by 8.0 wt % when the unammoniated zeolite content was increased to 175.0 wt %. However, a dramatic effect was seen in the root system, as by increasing the unammoniated zeolitic tuff content to 125.0 wt % a relative increase of 80.7 wt % o in root dry weight occurred.

As the zeolitic tuff additions contain no additional ammonia, the system must be benefiting from another property. A possible explanation is that the zeolitic water held in the channel structure is acting to “buffer” the loss of soil water by evaporation, in which case as the loss of soil water is slowed down the bacterial population will remain active for a longer period. Also, it was noticed that the substrates containing extra zeolitic tuff were draining faster than the unamended soil control which suggests that the soil porosity is increased by the presence of the zeolitic tuff. As nitrifying bacteria are chiefly aerobic, it is thought that an increased porosity will also benefit the population.

In order to test the function of zeolitic water, a series of measurements were made with a soil tensiometer to record the rate of loss of soil moisture. It was found that the presence of 65.0 wt % excess unammoniated zeolitic tuff decreased the rate of change of suction pressure, relative to an unamended garden soil substrate, by 45.5%. It can be inferred from this data that the presence of the zeolitic tuff has had a marked effect on the loss of soil moisture by evaporation. Work continues in order to quantify this effect.

Analytical Data

(a) Dry weights, Spring Wheat grown in uncontaminated soil

| | Sample | Shoot (g) | Root (g) |
|---|---|---|---|
| C.Gp1 | Unamended | 1.42 ± 0.26 | 0.14 ± 0.04 |
| C.Gp2 | Plus 16.7% bio-organic- | 7.67 ± 1.80 | 0.50 ± 0.16 |
| | zeolitic fertilizer | | |
| C.Gp3 | Ditto + 65% excess | 11.41 ± 2.25 | 0.69 ± 0.06 |
| | zeolitic tuff | | |
| C.Gp4 | Ditto + 125% excess | 11.32 ± 1.63 | 0.74 ± 0.19 |
| | zeolitic tuff | | |
| C.Gp5 | Ditto + 175% excess | 10.83 ± 2.17 | 0.72 ± 0.13 |
| | zeolitic tuff | | |
| C.Gp6 | Ditto + 225% excess | 12.50 ± 0.28 | 0.98 ± 0.35 |
| | zeolitic tuff | | |

(b) Dry weights, Ryegrass grown in contaminated soil

| | Sample | Shoot (g) | Root (g) |
|---|---|---|---|
| C.Gp1 | Unamended | 7.38 | 3.45 |
| C.Gp2 | Plus 16.7% bio-organic-zeolitic fertilizer | 31.46 | 6.53 |
| C.Gp3 | Ditto + 65% excess zeolitic tuff | 32.73 | 8.43 |
| C.Gp4 | Ditto + 125% excess zeolitic tuff | 33.36 | 11.80 |
| C.Gp5 | Ditto + 175% excess zeolitic tuff | 33.98 | 11.67 |
| C.Gp6 | Ditto + 225% excess zeolitic tuff | 28.87 | 7.44 |

(c) Tensiometer measurements

| | Time | Change in Tension | Rate |
|---|---|---|---|
| Sample | (hr) | Pressure (kPa) | (kPa · hr⁻¹) |
| C.Gp1 | 120 | 66.2 | 0.55 |
| C.Gp2 | 216 | 72.5 | 0.34 |
| C.Gp3 | 264 | 78.5 | 0.30 |

This research project was conducted to find ways of optimizing the process of production and the quality of Biogrow™. The investigation examined the effects of varying the concentrations of zeolite, the addition of wood ash, and the replacement of chicken manure with hog manure on the quality and agronomic use of Biogrow™.

Ten treatments were comprised of eight chicken manure treatments with 0, 2, 5, 10, 15, 20, 25, 33% zeolite. Treatments 9 and 10 contained chicken manure with 33% zeolite and 5% wood ash, and hog manure with 33% zeolite. All feedstocks were composted and the final compost used in a grow-out trial in which barley was used as the test species. Data collected included compost quality parameters, nutrient analysis, plant height, and biomass.

The following conclusions are evident from the results of the investigation:
Optimum zeolite concentration for composting of chicken manure for the production of Biogrow™ is 10%. The final compost obtained at 10% zeolite concentration significantly increased plant height and biomass for barley when compared to treatment 8 (33% zeolite) which has been the standard zeolite concentration in Biogrow™. This finding will significantly reduce the cost of production of Biogrow™ because the bulk of the cost of production is from the zeolite.

Addition of wood ash to the feedstock for Biogrow™ would not improve the quality of the product. Data from the research show that the addition of wood ash lowers the temperature during composting, and resulted in barley plants with significantly lower biomass.
Chicken manure-based Biogrow™ (treatments 8 and 9) had significantly higher macronutrients (NPK) than hog manure based products. Electrical conductivity (EC) values in the chicken manure based Biogrow™ were also significantly higher than EC value of hog manure based compost.
Hog manure-based Biogrow™ compost produced barley plants that were significantly higher in biomass and height than the chicken manure-based Biogrow™, however, the plants in the hog manure based Biogrow™ were turning yellow by 6 weeks.
Biogrow™ with 10% zeolite (treatment 4) gave the best performance in terms of biomass, plant height, and general plant health.
   Bioterra uses a patented process that converts a 2:1 mixture of chicken manure: zeolite into a soil enhancer called Biogrow™ through the process of composting. The use of zeolite for the absorption and storage of ammonia-N has been documented in literature for reducing nitrogen (N) loss during composting of manures (Kithome, Paul and Bomke, 1999; Witter and Kirchman, 1989). The loss of ammonia-N through volatilization accounts for most of the N lost during the process of composting.

In the production of Biogrow™, the current use of 33% zeolite by weight considerably increases the cost of production and reduces the amount of nutrients and organic matter that is available in the product. The claims of the patent owner (Peter Leggo, EP2000049051) only cover the 2:1 manure:zeolite ratio. The cost of Biogrow™ production would be dramatically reduced if lower ratios of zeolite are effective in locking-in the ammonia-N from volatilization.

This project investigates the effectiveness of varied rates of zeolite, addition of 5% wood ash and replacement of chicken manure with hog manure on Biogrow™ quality. It also investigates and quantifies the amount of nitrogen and other plant nutrients that are retained with different concentrations of zeolite in Biogrow™. This is the first step in optimizing Biogrow™ production.

Methodology

This project was conducted in two phases. The first phase involved the composting of the feedstock, while in the second phase, the compost produced was used for grow-out trials on barley in the greenhouse.

Phase 1:

This phase of the project was conducted at the OCCI Composting Technology Centre using a composting bin in-vessel system. Ten treatments were set up in duplicates to give a total of 20 bins. The ratios of zeolite to either chicken or hog manure by weight, and other additives for the treatments are listed in Table 1.

TABLE 1
Ratios of Zeolite

| | | Manure:Zeolite | % | Other |
|---|---|---|---|---|
| Treatment | Manure | Ratio | Zeolite | Additives |
| T1 | Chicken | 1:0 | 0 | |
| T2 | Chicken | 49:1 | 2 | |
| T3 | Chicken | 19:1 | 5 | |
| T4 | Chicken | 9:1 | 10 | |
| T5 | Chicken | 6.6:1 | 15 | |
| T6 | Chicken | 4:1 | 20 | |
| T7 | Chicken | 3:1 | 25 | |
| T8 | Chicken | 2:1 | 33 | |
| T9 | Chicken | 2:1 | 33 | 5% Wood Ash |
| T10 | Hog | 2.1 | 33 | |

The treatment mixes were set up as in Table 1, and the moisture content of each treatment was adjusted to provide 75% of the field capacity. The moisture content varied from as high as 55% in treatment 1 to as low as 35% in treatments 8, 9, and 10. Moisture content was adjusted when the value fell below expected range. At the onset of the project, moisture content, bulk density, pH, and organic matter content of the feedstocks were determined. Daily temperatures in and oxygen levels in the compost were measured in triplicates, and remedial actions taken when the values are outside expected range. The pH of the composts was measured, and volumes calculated on weekly basis. The composts were allowed to actively compost for eight weeks, and cure to stabilize. The final compost from each treatment was tested for phytotoxicity. Treatments 8, 9, and 10 were sent out to Norwest Labs for nutrient analysis.
Phase 2: Grow-Out Trials in the Greenhouse

Cured composts from Phase 1 of the project were used in the grow-out trials in the greenhouse. There were ten treatments from phase one and each treatment had 3 replicates. Eight inch pots were used, and the growth medium 25% (w/w) of compost mixed with Promix soilless media. A total of 30 pots were used. Barley was selected as the test species. Fifteen seeds were planted in each pot, and the pots were set out in a randomized block design in the greenhouse. The lighting in the green house was set to supplement natural light to provide 16 hours of daylight, and the temperature in the greenhouse was set to a minimum of 16° C. at night, and a maximum of 30° C. during the day. The pots were watered as needed.

The plants in each pot were thinned to ten at the 4-leaf growth stage. Plant heights were measured for each pot and averaged for each pot on a weekly basis. Qualitative observations were also made on the health and condition of the plants on a weekly basis. All plants were harvested after six weeks, and bagged in brown paper bags for drying. The plants were dried at 70° C. for 48 hours and weighed to determine the total biomass.

Statistical analyses were performed on the data obtained from the final plant height and biomass, to determine if there are significant differences between treatments.

Results and Discussions

Phase 1:

Phytotoxicity Testing (Cress Test)

Cress test was performed on the final composts. The results of the test are depicted in Table 2. According to the CCME guidelines for compost quality, a compost must obtain minimum of 90% of germination, and 50% biomass when compared with the control. All the composts passed the phytotoxicity test. This test implies that the compost will not harm plants when used at the specified rate of 25% by weight in growth media.

Bulk Density

Bulk densities of the feedstock and composts from the treatments are depicted in FIG. 1. As the zeolite component of the feedstock increases from 0% in treatment 1 to 33% in treatment 8, a gradual increase in bulk density is observed. This is expected since the bulk density of the zeolite is higher than the bulk density of either chicken or hog manure. When treatments 8 and 10 are compared, the hog manure has a higher bulk density than chicken manure.

TABLE 2
Data from phytotoxicity testing of the composts

| Treatment | % Germination | Biomass (%) |
|---|---|---|
| T1 | 100 | 100 |
| T2 | 97.5 | 192.87 |
| T3 | 97.5 | 259.78 |
| T4 | 102.5 | 298.38 |
| T5 | 107.5 | 238.42 |
| T6 | 100 | 274.37 |
| T7 | 110 | 172.85 |
| T8 | 102 | 255.65 |
| T9 | 100 | 195.7 |
| T10 | 112.5 | 420.02 |

Organic Matter Content

Organic matter content values of the final composts from the treatments are depicted in FIG. 2. As the zeolite content increases, organic matter content decrease. Zeolite is inorganic, therefore it is part of the mineral content of the compost. This result is expected, and it shows an inverse relationship between zeolite content and organic matter content, as between bulk density and organic matter content. It appears that the addition of 5% wood ash disproportionately increased the depletion of organic matter in the compost.

pH

Changes in pH in the treatments during composting are depicted in Table 3. Increasing the zeolite concentrations from 0% in treatment 1 to 33% gradually decreased the pH in the feedstocks from 7.8 to 6.05, but the pH in treatments 1 to 8 increased gradually compost during the process of composting to about 9. Addition of 5% wood ash to the feedstock in treatment 9 significantly increased the pH of the feedstock from about 7 to 11.38. The composting process also moderated the pH in treatment 9. At the end of the composting, there was no significant difference between composts that were with or without wood ash. Composting therefore reduces the liming capacity of the wood ash when added to the feedstock. Hog manure compost had a significantly lower pH (about 7) throughout the process. High pH in chicken manure is mainly due to high ammonia-N in the compost.

[image]

TABLE 3
pH changes during the composting process.

| | Date | | | |
|---|---|---|---|---|
| | Apr. 1, 2003 | Apr. 11, 2003 | Apr. 25, 2003 | May 26, 2003 |
| T1 | 7.82 | 8.36 | 8.195 | 9.225 |
| T2 | 7.51 | 8.22 | 8.32 | 9.22 |
| T3 | 7.48 | 8.11 | 8.1 | 9.15 |
| T4 | 7.6 | 8.17 | 8.2 | 9.11 |
| T5 | 7.3 | 8.14 | 8.2 | 9.11 |
| T6 | 7.105 | 8.13 | 8.215 | 9.02 |
| T7 | 6.74 | 8.18 | 8.165 | 9.06 |
| T8 | 6.605 | 8.13 | 8.115 | 8.885 |
| T9 | 11.38 | 8.96 | 8.21 | 8.9 |
| T10 | | 7.77 | 6.73 | 7.3 |

Temperature

Mean daily temperature values for the treatments are depicted in Table 4, and graphically presented in FIG. 3. Although there were no specific patterns in temperature that can be attributed to the concentrations of zeolite used, all composts attained temperatures in excess of 55° C. for a minimum of 3 days. The CCME Compost Quality Guidelines specifies that a minimum temperature of 55° C. is required for a minimum of 3 days in in-vessel systems for effective pathogen control. Indicator organisms of fecal pollution such as Escherichia coli and Salmonella sp. are destroyed at such thermophilic temperatures. The addition of wood ash appears to lower the temperature prematurely. Temperatures in all treatments were significantly higher than the ambient.

TABLE 4
Mean ambient and treatment temperatures (° C.) during composting compost

| mm/dd/yy | Amb | T1 | T2 | T3 | T4 | T5 | T6 | T7 | T8 | T9 | T10 |
|---|---|---|---|---|---|---|---|---|---|---|---|
| Apr. 01, 2003 | 18.0 | 51.0 | 47.5 | 45.0 | 46.0 | 37.5 | 48.5 | 39.5 | 35.0 | | |
| Apr. 02, 2003 | 18.0 | 49.5 | 48.0 | 49.5 | 54.5 | 50.5 | 49.0 | 48.0 | 46.5 | | |
| Apr. 03, 2003 | 18.0 | 57.0 | 48.8 | 56.0 | 58.0 | 59.0 | 56.0 | 53.0 | 52.0 | | |
| Apr. 04, 2003 | 18.0 | 55.0 | 49.5 | 56.5 | 56.0 | 56.5 | 55.5 | 48.0 | 52.0 | 46.0 | |
| Apr. 07, 2003 | 18.0 | 59.0 | 53.5 | 57.5 | 55.5 | 59.0 | 55.5 | 53.0 | 52.5 | 55.0 | |
| Apr. 08, 2003 | 20.0 | 47.0 | 62.0 | 57.0 | 58.5 | 62.0 | 55.0 | 53.5 | 56.5 | 56.0 | |
| Apr. 09, 2003 | 20.0 | 51.0 | 60.5 | 58.0 | 58.0 | 60.5 | 54.0 | 53.5 | 55.5 | 55.0 | |
| Apr. 10, 2003 | 20.0 | 55.0 | 54.5 | 51.0 | 55.5 | 58.0 | 55.5 | 56.0 | 60.0 | 55.0 | |
| Apr. 11, 2003 | 20.0 | 61.5 | 59.0 | 60.5 | 58.0 | 60.0 | 57.0 | 53.5 | 57.0 | 52.0 | 29.0 |
| Apr. 14, 2003 | 20.0 | 54.0 | 60.0 | 59.0 | 58.0 | 58.5 | 52.0 | 60.0 | 58.5 | 37.0 | 64.0 |
| Apr. 15, 2003 | 16.0 | 53.0 | 52.0 | 56.0 | 54.0 | 58.0 | 48.5 | 59.5 | 56.5 | 36.0 | 59.0 |
| Apr. 16, 2003 | 16.0 | 44.0 | 53.5 | 60.5 | 55.0 | 56.0 | 54.0 | 60.0 | 53.0 | 35.0 | 55.0 |
| Apr. 17, 2003 | 16.0 | 45.0 | 50.0 | 56.5 | 50.5 | 54.0 | 52.0 | 59.0 | 53.0 | 35.0 | 52.0 |
| Apr. 22, 2003 | 18.0 | 42.5 | 44.0 | 47.0 | 45.0 | 47.0 | 46.0 | 51.0 | 51.5 | 38.0 | 42.0 |
| Apr. 23, 2003 | 18.0 | 41.0 | 42.0 | 45.0 | 44.0 | 41.5 | 48.0 | 53.5 | 52.0 | 35.0 | 38.0 |
| Apr. 24, 2003 | 18.0 | 41.5 | 41.0 | 45.5 | 45.0 | 47.0 | 45.5 | 50.0 | 51.5 | 34.0 | 35.0 |
| Apr. 25, 2003 | 18.0 | 42.0 | 50.0 | 44.0 | 40.5 | 43.5 | 41.0 | 51.0 | 49.0 | 33.0 | 33.0 |
| Apr. 29, 2003 | 18.0 | 36.5 | 37.0 | 41.0 | 37.3 | 42.8 | 40.0 | 45.0 | 42.5 | 35.0 | 31.0 |
| Apr. 30, 2003 | 18.0 | 36.5 | 37.0 | 35.0 | 34.0 | 42.0 | 39.0 | 39.0 | 36.0 | 37.0 | 29.0 |
| May 01, 2003 | 18.0 | 41.5 | 39.0 | 37.0 | 36.0 | 38.0 | 35.0 | 34.0 | 33.0 | 39.0 | 34.0 |
| May 02, 2003 | 18.0 | 42.5 | 40.0 | 42.0 | 40.0 | 40.5 | 39.5 | 35.5 | 37.5 | 40.0 | 37.0 |
| May 05, 2003 | 18.0 | 44.0 | 42.0 | 43.5 | 42.0 | 47.0 | 44.0 | 41.0 | 41.5 | 41.0 | 34.0 |
| May 06, 2003 | 18.0 | 44.0 | 45.0 | 43.5 | 45.0 | 48.0 | 44.5 | 42.0 | 43.5 | 35.0 | 33.0 |
| May 08, 2003 | 18.0 | 49.0 | 47.0 | 44.5 | 44.5 | 44.5 | 42.0 | 40.5 | 41.5 | 43.0 | 30.0 |
| May 12, 2003 | 18.0 | 48.5 | 49.0 | 48.0 | 46.5 | 47.5 | 44.0 | 43.0 | 43.5 | 46.0 | 35.0 |
| May 13, 2003 | 18.0 | 50.0 | 51.0 | 48.5 | 47.5 | 48.0 | 45.0 | 43.5 | 44.0 | 47.0 | 35.0 |
| May 14, 2003 | 18.0 | 54.0 | 54.0 | 52.0 | 48.5 | 50.0 | 48.0 | 46.5 | 46.5 | 45.0 | 36.0 |
| May 15, 2003 | 18.0 | 58.0 | 53.0 | 55.5 | 51.0 | 52.5 | 47.0 | 46.0 | 46.5 | 41.0 | 36.0 |
| May 16, 2003 | 18.0 | 56.5 | 55.0 | 54.0 | 52.5 | 53.0 | 48.0 | 47.0 | 47.0 | 41.0 | 37.0 |
| May 20, 2003 | 18.0 | 54.0 | 52.0 | 52.5 | 49.5 | 49.5 | 49.5 | 47.0 | 45.5 | 49.0 | 38.0 |
| May 23, 2003 | 18.0 | 52.0 | 48.0 | 49.0 | 46.0 | 50.5 | 45.0 | 45.5 | 43.0 | 48.0 | 38.0 |

[image]

Nutrient Analysis

Table 5 depicts the nutrient analytical data for treatments 8, 9 and 10. The addition of wood ash resulted in about 10% loss in available nitrogen. Most of the losses would be in the form of ammonia gas due to the high pH caused by the fly ash. The fly ash also increased the mineral content including Na, Ca, Mg, K. When compared to treatments 8 and 9, hog manure plus zeolite compost (treatment 10) was significantly lower in available nitrogen, total nitrogen, P, K, Na and Mg. Electrical conductivity values of the chicken manure based Biogrow™ (8 and 9) were about 35% higher than in hog manure-based Biogrow™.

TABLE 5
Nutrient analysis of Biogrow ™ products containing 33% zeolite.

| | Dry Basis | | | |
|---|---|---|---|---|
| Analyte | Unit | T8 | T9 | T10 |
| Available C:N Ratio | | 2.54 | 5.14 | 4.82 |
| Available Nitrogen | % | 1.32 | 1.18 | 0.48 |
| C:N Ratio | | 7.51 | 6.84 | 6.56 |
| Total Carbon | % | 13.73 | 11.51 | 4.44 |
| Total Nitrogen | % | 1.83 | 1.66 | 0.68 |
| Total Sulphur | % | 0.58 | 0.71 | 0.52 |
| Available Carbon | % | 3.37 | 6.08 | 2.31 |
| Sodium | % | 0.517 | 0.587 | 0.308 |
| SAR | % | 0.406 | 0.339 | 0.378 |
| Calcium | % | 2.639 | 5.156 | 1.361 |
| K2O | % | 1.49 | 1.94 | 1.25 |
| Magnesium | % | 0.601 | 0.829 | 0.404 |
| P205 | % | 2.583 | 2.564 | 0.699 |
| Phosphorus | % | 1.127 | 1.119 | 0.305 |
| Potassium | % | 1.23 | 1.61 | 1.04 |
| Moisture | % | 40.9 | 34 | 29.4 |
| pH (wet values) | | 7.6 | 8.2 | 6.4 |
| EC (wet values) | uS/cm | 52.5 | 48.9 | 36.5 |
| Ash (wet values) | % | 71.54 | 73.89 | 87.89 |
| Available Organic Matter | % | 6.73 | 12.2 | 4.62 |
| Organic Matter | % | 28.4 | 26.1 | 12.1 |
| Neutral Detergent | % | 58.8 | 56.18 | 79.37 |
| Insoluble Ash | | | | |
| Neutral Detergent Fibre | % | 21.72 | 13.95 | 7.49 |

Phase 2:
Plant Height

FIG. 4 shows the growth curves of barley plants grown in the 10 treatment media. Treatments were also grouped into 3 for easy analysis. Table 6 shows the result of the Student T-test analysis on the plant height data for the 10 treatments. The addition of zeolite significantly improves the quality of the compost. Treatments 4 and 10 produced barley plants that were significantly taller than the other treatments. Table 7 shows the result of the T-test for treatments 1 to 7 (0-25% zeolite). Treatment 4 (10%) produced significantly taller barley than other 6 treatments. Table 8 depicts the results of the Student-Newman-Keul Test for treatments 8, 9 and 10. It shows that the addition of wood ash to Biogrow™ would significantly increase plant height. At the same time, the use of hog manure in Biogrow™ produced taller plants than when chicken manure was used.

TABLE 6
Table of T test for plant height. (Means with the
same letter are not significantly different)

| Mean (cm) | N | Treatment | T Grouping |
|---|---|---|---|
| 65.667 | 3 | 4 | A |
| 65.33 | 3 | 10 | A |
| 60.33 | 3 | 9 | A, B |
| 59.67 | 3 | 6 | A, B |
| 57.33 | 3 | 5 | B |
| 57.33 | 3 | 3 | B |
| 57.00 | 3 | 8 | B |
| 55.33 | 3 | 7 | B, C |
| 50.33 | 3 | 2 | C |
| 41.67 | 3 | 1 | D |

TABLE 7
Table of T test for plant height. (Means with the
same letter are not significantly different)

| Mean | N | Treatment | T Grouping |
|---|---|---|---|
| 65.667 | 3 | 4 | A |
| 59.67 | 3 | 6 | B |
| 57.33 | 3 | 5 | B |
| 57.33 | 3 | 3 | B |
| 55.33 | 3 | 7 | B, C |
| 50.33 | 3 | 2 | C |
| 41.67 | 3 | 1 | D |

TABLE 8
Table of Student-Newman-Keul test for plant heights (8, 9, 10).
(Means with the same letter are not significantly different)

| Mean | N | Treatment | SNK Grouping |
|---|---|---|---|
| 65.33 | 3 | 10 | A |
| 60.33 | 3 | 9 | A, B |
| 57.00 | 3 | 8 | B |

[image]

Plant Biomass

FIG. 5 shows the histograms for biomass of barley plants grown in the 10 treatment media. Treatments were also grouped into 3 for easy analysis. Table 9 shows the result of the Student T-test analysis on the biomass per pot for the 10 treatments. The addition of zeolite significantly improved the quality of the compost and significantly increased plant biomass. Treatment 10 produced barley plants that were significantly heavier than the other treatments Table 7 shows the result of the T-test for treatments 1 to 7 (0-25% zeolite). Treatment 4 (10%) ranked highest in terms of the biomass of barley plants. Table 8 depicts the results of the Student-Newman-Keul Test for treatments 8, 9 and 10. There were no significant differences between the three treatments in terms of plant biomass production. This means that though the use of wood ash and hog manure in Biogrow™ would produce taller, but less robust plants.

[image]

TABLE 9
Table of T test for plant biomass per pot. (Means with
the same letter are not significantly different)

| Mean (g) | N | Treatment | T Grouping |
|---|---|---|---|
| 14.196 | 3 | 10 | A |
| 10.104 | 3 | 4 | B |
| 9.273 | 3 | 6 | B, C |
| 8.780 | 3 | 3 | B, C, D |
| 8.640 | 3 | 8 | B, C, D |
| 8.041 | 3 | 5 | B, C, D |
| 6.614 | 3 | 9 | C, D |
| 6.517 | 3 | 2 | C, D |
| 5.842 | 3 | 7 | D |
| 3.277 | 3 | 1 | E |

TABLE 10
Table of T test for plant biomass per plant (Means with
the same letter are not significantly different)

| Mean (g) | N | Treatment | T Grouping |
|---|---|---|---|
| 1.0104 | 3 | 4 | A |
| 0.9273 | 3 | 6 | A |
| 0.8780 | 3 | 3 | A |
| 0.8041 | 3 | 5 | A, B |
| 0.6517 | 3 | 2 | B, C |
| 0.5842 | 3 | 7 | C |
| 0.3277 | 3 | 1 | D |

TABLE 11
Table of Student-Newman-Keul test for biomass/pot (8, 9, 10).
(Means with the same letter are not significantly different)

| Mean (g) | N | Treatment | SNK Grouping |
|---|---|---|---|
| 14.196 | 3 | 10 | A |
| 8.640 | 3 | 8 | A |
| 6.614 | 3 | 9 | A |

Plant Health

The final pictures of the plants taken on August 25 show the health of the plants. Though treatment ranked highest in plant height and second in height, the plants were unhealthy and were yellowing by the time of harvesting of the shoot. This confirms the limitation of nitrogen in the hog manure compost. Chicken manure-based Biogrow™ products were better. Plates 1 to 10 show the plants just before biomass sampling.

[image]

[image]

[image]

[image]

[image]

[image]

Conclusions and Recommendations

Optimum zeolite concentration for composting of chicken manure for the production of Biogrow™ is 10%. The final compost obtained at 10% zeolite concentration significantly increase plant height and biomass for barley when compared to treatment 8 (33% zeolite) which has been the standard zeolite concentration in Biogrow™. This finding will significantly reduce the cost of production of Biogrow™ because the bulk of cost of production is from the zeolite.

Addition of wood ash to the feedstock for Biogrow™ would not improve the quality of the product. Data from the research show that the addition of wood ash lowers the temperature during composting, and resulted in barley plants with significantly lower biomass.

Chicken manure-based Biogrow™ (treatments 8 and 9) had significantly higher macronutrients (NPK) than hog manure based products. Electrical conductivity (EC) values in the chicken manure based Biogrow™ were also significantly higher than EC value of hog manure-based compost.

Hog manure based Biogrow™ compost produced barley plants that were significantly higher in biomass and height than the chicken manure-based Biogrow™. The differences in height and biomass appeared to be due to either low EC values or other micronutrients in the hog manure compost. The plants in treatment 10 were turning yellow by 6 weeks.

Biogrow™ with 10% zeolite (treatment 4) gave the best performance in terms of biomass, plant height and general plant health.

### REFERENCES

Canadian Council of Ministers of Environment (CCME) 1996. Guidelines on Compost Quality.
Kithome, M, J. W. Paul and A. A. Bomke. 1999. Reducing Nitrogen Losses during Simulated Composting of Poultry manure using Absorbents or Chemical Amendments. J Environ. Qual. 28:194-201.
Witter, E, and H. Kirchmann. 1989. Peat, zeolite and basalt as absorbents of ammonical nitrogen during manure decomposition. Plant Soil 115:43-52.

In-situ immobilization of metals and re-vegetation of the site is an economically and environmentally favorable option for the remediation of sites contaminated by mine tailings. Stabilization of the soil surface through re-vegetation will prevent contaminant transport through wind erosion and leaching to groundwater. Immobilization of heavy metals can be achieved through the addition of appropriate amendments. A greenhouse study was undertaken to determine the effect of a combination of a zeolite based fertilizer (Biogrow™) and wood ash on vegetation establishment on mine tailings. The tailings were obtained from Lynn Lake, Manitoba, with elevated concentrations of Ni, Cr, and Cu. Preliminary results indicate that coupling the application of Biogrow™ at 20% and wood ash at 1% provides an optimum balance of pH change and superior vegetation establishment on mine tailings.

In-situ immobilization of metals and re-vegetation of the site is an economically and environmentally favorable option for the remediation of sites contaminated by mine tailings. Stabilization of the soil surface through re-vegetation will prevent contaminant transport through wind erosion and leaching to groundwater. Immobilization of heavy metals can be achieved through the addition of appropriate amendments. A greenhouse study was undertaken to determine the effect of a combination of a zeolite based fertilizer (Biogrow™) and wood ash on vegetation establishment on mine tailings. The tailings were obtained from Lynn Lake, Manitoba, with elevated concentrations of Ni, Cr, and Cu. Preliminary results indicate that coupling the application of Biogrow™ at 20% and wood ash at 1% provides an optimum balance of pH change and superior vegetation establishment on mine tailings and the inhibited mobility of subsurface contaminants.

Heavy metal contaminants found in mine tailings pose a significant human and environmental health risk. Remediation of these sites is a serious environmental challenge. Tailings remain completely void of vegetation as a result of elevated concentrations of heavy metals such as copper, nickel and chromium, coupled with low concentrations of nitrogen, phosphorus and other essential plant nutrients. Other factors limiting vegetation establishment on mine tailings include low pH, salinity, compaction, surface crusting, biological sterility and lack of nutrient cycling. Toxic metals are prone to wind erosion and leaching to groundwater. In-situ immobilization techniques based on the use of appropriate amendments are favored in cases where the elimination of toxic metals is not economically feasible.

Phytostabilization using a zeolite-based organofertilizer, Biogrow™, has proven to be an economically and environmentally effective option in the prevention of contaminant transport and vegetative toxicity associated with mine tailings. Greenhouse studies and a field study investigating the effect of Biogrow™ on vegetation establishment in mine tailings with elevated concentrations of nickel, copper and chromium have been highly successful. Addition of Biogrow™ served to moderate pH, supply essential plant nutrients and organic matter, improve shoot and root production, reduce surface crusting, lower soil density and overall, promote healthy vegetation establishment on the mine tailings (Chaw, 2002; Cody, 2003). In cases of extreme acidity, the pH increase associated with Biogrow™ application may be insufficient to maintain pH within an optimum range for microbial and vegetative growth as well as reduced metal bioavailability. In this case, an additional pH amendment may be favorable.

When materials such as coal or sawdust are burned at very high temperatures, a powdery grey ash remains, commonly known as fly ash. The calcium carbonate equivalence, oxide and carbon content and pH of the fly ash will vary depending on the type of material burned. The huge quantity of fly ash produced poses environmental challenges in land usage; plant, animal and human health risk; and groundwater contamination. There are numerous uses for fly ash, and if properly managed can be a valuable resource rather than a waste. Wood ash has been used as a source of phosphorus and potassium in agronomic applications (Erich, 1991). Wood ash contains almost all elements required for plant growth except organic carbon and nitrogen. It improves soil texture, increases bulk density which in turn improves soil porosity, workability, root penetration and moisture retention, increases water holding capacity of the soil, reduces encrustation and increases plant growth. Amendment of acidic soils with ash increases pH substantially, immobilizing heavy metals and bringing pH to neutral values. In a column study, the heavy metal content of leachate was drastically reduced through amendment of mine tailings with fly ash (Ciccu, internet article). Unlike fly ash from coal burning, which may have elevated concentrations of heavy metals, wood ash typically has very low levels of trace elements that meet CCME guidelines and limits set by the Fertilizers Act.

Researchers experimenting with combinations of amendments in remediation of mine tailings have found that bioavailability of lead in mine tailings was decreased through surface amendments of compost with wood ash in a wetland (reducing) environment (DeVolder, 2003). The complementary pH altering ability of wood ash and superior vegetation establishment capability of Biogrow™ prompted Steve Dunn of Meridian Inc. to couple the application of the two products as a remediation technique.

This is referred to as Biogrow Ultra, a cost effective technique to prevent mobility of heavy metals and promote a soil environment conducive to plant growth. The main objective of this study was to investigate the effects of wood ash amendment, independently and as Biogrow Ultra, on pH, germination, plant height, plant health and biomass production in mine tailings from Lynn Lake, Manitoba.

Materials and Methods

Product Development

Biogrow™ was produced through co-composting of zeolite and chicken manure, according to the procedure outlined in ‘Evaluation of Zeolite Based Fertilizers for Reclamation of Mine Tailings—Final Report’ (Chaw, 2002). Analysis of the product is given in Table 1.

TABLE 1
Chemical analysis of Biogrow ™

| Parameter | Dry weight basis |
|---|---|
| Moisture (%) | 38.20 |
| pH | 7.4 |
| E.C. (dS/m) | 49.4 |
| Organic Matter (%) | 26.0 |
| C:N ratio | 7.63 |
| Total Nitrogen (%) | 1.57 |
| Available Nitrogen (%) | 1.28 |
| Total Carbon (%) | 12.01 |
| Available Carbon (%) | 6.10 |
| SAR | 0.06 |
| Sodium (%) | 0.54 |
| Calcium (%) | 2.57 |
| Potassium (%) | 1.57 |
| Phosphorus (%) | 0.86 |

Wood ash was obtained from the Louisiana Pacific mill in Manitoba. Analysis of this product is given in Tables 2 and 3. Essential plant nutrients are highlighted.

TABLE 2
Metal (strong acid extractable) Analysis of Wood Ash (primary burner)

| Element | Concentration (ug/g) |
|---|---|
| Mercury | 0.01 |
| Aluminum | 11700 |
| Antimony | 0.5 |
| Arsenic | 2.8 |
| Barium | 452 |
| Beryllium | 0.22 |
| Bismuth | <0.4 |
| Cadmium | 0.33 |
| Calcium | 187000 |
| Chromium | 15.3 |
| Cobalt | 3.39 |
| Copper | 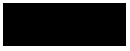 |
| Iron | 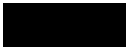 |
| Lead | 0.6 |
| Lithium | 18.8 |
| Magnesium | 41300 |
| Manganese | 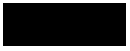 |
| Molybdenum | 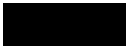 |
| Nickel | 12.6 |
| Phosphorus | 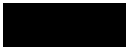 |
| Potassium | 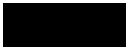 |
| Selenium | 0.9 |
| Silicon | 248 |
| Silver | <0.05 |
| Sodium | 7570 |
| Strontium | 264 |
| Thallium | <0.2 |
| Tin | 2.5 |
| Titanium | 352 |
| Vanadium | 20.0 |
| Zinc | 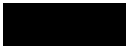 |

The ash is very high in aluminum, calcium and magnesium. The pH of the wood ash is between 12 and 13 which is extremely alkaline. The calcium carbonate equivalence of the wood ash is near 100%, also very high. Hydroxides and oxides are more effective than calcium carbonate in increasing alkalinity. Oxides are common in ash, hence calcium carbonate equivalents can be greater than 100%. In the wood ash obtained for this project, SiO₂ and CaO comprised the largest percentages of oxides.

TABLE 3
Oxide concentrations in wood ash

| P₂O₅ | SiO₂ | Al₂O₃ | Fe₂O₃ | CaO | MgO | Na₂O | K₂O | TiO₂ | MnO |
|---|---|---|---|---|---|---|---|---|---|
| (%) | (%) | (%) | (%) | (%) | (%) | (%) | (%) | (%) | (%) |
| 1.9 | 28.03 | 2.68 | 1.40 | 42.9 | 5.63 | 2.07 | 5.17 | 0.12 | 0.09 |

The mine tailings used were obtained from an abandoned nickel and copper mine in Lynn Lake, Manitoba. Concentrations of copper (275 mg/kg), nickel (215 mg/kg), and chromium (303 mg/kg) are above the guideline recommended by the Canadian Council of Ministers of the Environment (CCME) for industrial sites (guideline thresholds for industrial sites are 91, 50, and 87 mg/kg respectively)(CCME 2002). Nickel toxicity against vegetation on this site seems likely. An analysis of the mine tailings is provided in Table 4.

TABLE 4
Tailings characteristics (Lynn Lake, MB)

| Characteristic | Mean | SD |
|---|---|---|
| Sand (%) | 53 | 16.5 |
| Silt (%) | 5 | 2.7 |
| Clay (%) | 41 | 19.2 |
| pH | 4.3 | 0.5 |
| EC (dS/m) | 4.3 | 1.1 |
| OM (%) | 1.5 | 1.6 |

mg/kg

| | | |
|---|---|---|
| Nitrogen | 16.7 | 14.2 |
| Phosphorus | 5.6 | 1.0 |
| Potassium | 42.0 | 13.9 |
| Sulfur | 20.0 | 0.0 |
| Mercury | 0.0 | 0.0 |
| Antimony | 0.6 | 0.6 |
| Arsenic | 1.2 | 0.7 |
| Barium | 52.4 | 8.5 |
| Beryllium | 0.0 | 0.0 |
| Cadmium | 0.2 | 0.0 |
| Chromium | 303.0 | 63.2 |
| Cobalt | 10.3 | 3.5 |
| Copper | 274.7 | 54.3 |
| Lead | 5.2 | 1.2 |
| Molybdenum | 0.4 | 0.1 |
| Nickel | 215.3 | 83.9 |
| Selenium | 5.4 | 2.0 |
| Silver | 0.7 | 0.1 |
| Thallium | 0.3 | 0.1 |
| Tin | 0.4 | 0.2 |
| Vanadium | 24.4 | 6.7 |
| Zinc | 39.9 | 2.4 |

Greenhouse Trial

The test species chosen for this experiment were Crested wheatgrass (Agropyron desertorum) and Penncross bentgrass (Agrostis palustris). There were a total of eight treatments. Unamended mine tailings from Lynn Lake served as the control. Two treatments consisted of mine tailings amended with wood ash at either a 1% rate, corresponding to an application rate of 10 tonnes/ha, or 2.5%, corresponding to 26 tonnes/ha. The USEPA recommended application rate is 10 tonnes/ha, though an optimum application rate of 26 tonnes/ha has been reported. Two more treatments received wood ash at the two rates, coupled with urea as a nitrogen source. One treatment received Biogrow™ while the last two treatments received Biogrow Ultra at the 1% or 2.5% amendment rate. A treatment list is provided in Table 5.

TABLE 5
Treatments used for the growth of Crested
Wheatgrass and Penncross bentgrass.

| Treatment | Growth Medium |
|---|---|
| 1 | Untreated mine tailings from Lynn Lake as a control |
| 2 | Ash application rate of 1% which corresponds to 10 |
| | tonnes/ha |
| 3 | Ash application rate of 2.5% which corresponds to 26 |
| | tonnes/ha. |
| 4 | Ash application rate of 1% with synthetic nitrogen |
| | fertilizer (urea) application as a source of nitrogen |
| 5 | Ash application rate of 2.5% with synthetic nitrogen |
| | fertilizer (urea) application as a source of nitrogen |
| 6 | Ash application rate of 1% plus 20% Biogrow ™ |
| 7 | Ash application rate of 2.5% plus 20% Biogrow ™ |
| 8 | 20% Biogrow ™ compost |

Due to limited quantities of mine tailings and Biogrow™, pots were replicated only twice, resulting in a total of 32-4 inch pots. Plants were grown in azalea pots and arranged in a complete randomized configuration. Approximately 100 seeds of either species (measured by weight) were sown onto the surface and scratched in. All pots were watered daily using an automatic misting system. Temperatures in the greenhouse were maintained at approximately 24° C. during the day and 12° C. at night. Supplemental light was added to allow for a 16 hour daylight cycle for the first 3 weeks of the trial. Supplemental light was not required after this time due to the natural extension of daylight hours. Germination was recorded on a daily basis for 14 days and plant height on a weekly basis throughout the trial. Initial pH was recorded for all treatments. Plants were grown for 8 weeks, after which all plants were harvested for above-ground biomass determination. Above-ground biomass was clipped just above the soil surface. Plant material was weighed and dried at 60° C. until reaching a constant weight. Selected composite samples were sent to an external contract laboratory for metal analysis. Final pH and electrical conductivity of the soil was determined following shaking of the soil from the plant roots. Precipitate appearing on control and Biogrow pots was collected and sent to an external laboratory for analysis.

Results and Discussions:

Plant growth response data was analyzed by making comparisons of results based on treatment type and ash rate.

FIG. 1 illustrates treatment comparisons in final seed germination. Seeds germinated at approximately the same time, on day 7. Germination was complete for all treatments after 14 days. There did not appear to be much difference in germination percentages between treatments. Germination of crested wheatgrass was approximately 25-35% in all treatments except the unamended control. Unlike with the crested wheatgrass, the control pots in the penncross bentgrass germinated approximately as well as the other treatments. Seed mortality with grass species is high and typically high seeding rates are used to account for the low germination rate. Unamended controls experienced flooding as a result of the reduced infiltration of water at the surface and crusting occurred after the pots dried out. This crusting was not observed in the treated mine tailings.

[image]

Plant height is one of several indicators of plant health and growth performance. Height of the plants could be retarded due to contaminants, phytotoxins, low nutrients, or high salinity in the media. For both plant species, any seeds that germinated in the unamended mine tailings experienced very poor growth, as was expected. Initially, treatments 2-8 were very similar in plant height but after Week 4, Biogrow™ and Biogrow Ultra treatments began to excel. By Week 8, incremental increases in plant height could be seen as treatment number increased. Ash alone produced greater plant heights than the control pots. Ash with urea produced greater plant heights than ash alone. Biogrow™ and Biogrow Ultra produced the tallest plants. Plant height appeared to be very similar between the two ash application rates, with perhaps a slight trend towards decreased plant height in the 2.5% ash rate. This trend among the two rates was not seen in plant height measurements for the ash alone or ash plus urea treatments.

[image]

Biomass production correlated well with plant height results. Biogrow™ and Biogrow Ultra treatments produced the highest biomass production per pot. Clearly, the Biogrow™ and Biogrow Ultra provides much more than a nitrogen source, based on its performance compared to the urea treatments. Biomass production appears to be slightly better with a 1% ash application rate than a 2.5% rate in Biogrow Ultra. This may indicate that there is some growth inhibition at greater ash amendment rates but further study is required to confirm the significance of this result. Biogrow™ outperformed all other treatments in both plant species with respect to biomass production.

[image]

Perhaps one of the greatest concerns with regards to metal mobility is soil pH. Initial and final pH measurements according to treatment number and species are provided in Table 6.

TABLE 6
Initial and Final pH Measurements

| | Initial | Final | Final |
|---|---|---|---|
| Treatment | pH | pH-PB | pH-CW |
| 1 | 3.19 | 4.23 | 4.22 |
| 2 | 7.42 | 7.24 | 7.20 |
| 3 | 10.08 | 7.92 | 7.84 |
| 4 | 7.53 | 7.59 | 7.12 |
| 5 | 9.65 | 7.93 | 8.64 |
| 6 | 7.86 | 7.33 | 6.93 |
| 7 | 9.94 | 7.95 | 8.16 |
| 8 | 4.26 | 4.52 | 4.26 |

Unamended mine tailings are extremely acidic. A favorable range for microbial activity, vegetative growth and reduced metal bioavailability is typically accepted to be between 6-8. Initially, treatments 2, 4, and 6, altered the pH of the tailings to within this optimum range. This corresponds to the amendment with 1% wood ash. Final pH measurements indicated that all treatments receiving wood ash had pH values within the optimum range, with the exception of treatments 5 and 7 (2.5% ash rates) in the crested wheatgrass. The Biogrow™ treatment was successful in producing a moderate pH change, but Biogrow Ultra appeared to be superior in this respect.

[image]

Electrical conductivity was highest in treatments receiving Biogrow™, as the EC is relatively high in this product. A low sodium adsorption ratio (SAR) for Biogrow™ indicates that the high EC value is a result of a high percentage of calcium and magnesium ions relative to sodium ions in the product. For this reason, salinity should not pose a problem.

Composite samples of treatment 6, 7, and 8 in the penncross bentgrass were collected and sent to Norwest Labs for tissue concentrations of metals. The results are presented in Table 7. Tissue concentrations exceeding the target value are highlighted.

TABLE 7
Tissue Analysis of Selected Treatments in Penncross Bentrgrass

| | | Treatment | Treatment | Treatment | Target |
|---|---|---|---|---|---|
| Analyte | Units | 6 | 7 | 8 | Range |
| Calcium | % | 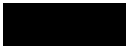 | 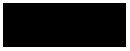 | 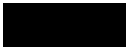 | 0.40-0.79 |
| Phosphorus | % | 0.32 | 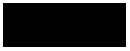 | 0.30 | 0.30-0.49 |
| Potassium | % | 1.69 | 2.53 | 1.68 | 2.00-3.99 |
| Magnesium | % | 0.21 | 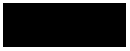 | 0.19 | 0.20-0.39 |
| Sodium | % | 0.04 | 0.16 | 0.08 | 0.10-0.19 |
| Total Sulphur | % | 0.35 | 0.34 | 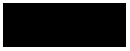 | 0.20-0.39 |
| Zinc | ppm | 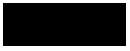 | 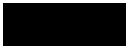 | 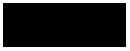 | 25.0-60.0 |
| Boron | ppm | 10 | 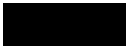 | 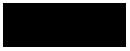 | 10.0-20.0 |
| Manganese | ppm | 140 | 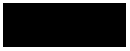 | 195 | 30.0-200.0 |
| Copper | ppm | 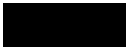 | 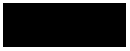 | 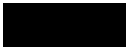 | 5.0-20.0 |
| Iron | ppm | 134 | 245 | 127 | 50.0-300.0 |
| Molybdenum | ppm | 1.1 | 2.0 | 1.6 | |
| Aluminum | ppm | 47 | 99.0 | 55 | |
| Antimony | ppm | <10 | <20 | <10 | |
| Arsenic | ppm | <3 | <5 | <3 | |
| Cadmium | ppm | <0.4 | <0.6 | <0.4 | |
| Chromium | ppm | 3.6 | 4.2 | 3.6 | |
| Cobalt | ppm | <0.7 | <1 | <0.8 | |
| Lead | ppm | <10 | <20 | <10 | |
| Nickel | ppm | 43.4 | 48.8 | 46.3 | |
| Scandium | ppm | <0.4 | <0.6 | <0.4 | |
| Strontium | ppm | 47.1 | 97.9 | 36.1 | |
| Titanium | ppm | <0.4 | <0.6 | <0.4 | |
| Vanadium | ppm | 0.4 | 0.8 | <0.4 | |
| Selenium | ppm | <6 | <9 | <6 | |

Although statistical analysis is not possible due to the composite nature of the sampling, the results indicate that zinc and copper toxicity should be watched for in this plant species. Zinc and copper uptake to plant tissue did not appear to be a concern in the field trial in Manitoba where a seed mix of Creeping Red Fescue, Timothy, and Alsike Clover was used (Cody, 2003). This indicates that plant species should be chosen appropriately in re-vegetation attempts. Nickel and chromium do not appear to be a concern in the penncross bentgrass tissue, despite their elevated concentrations in the soil. The wood ash has high concentrations of iron, calcium, aluminum, and magnesium, but it would appear that the addition of 1% Biogrow Ultra to mine tailings maintains the tissue concentrations of these elements within the target range. From these results, there is no strong indication of an immobilization effect from soil to plant tissue due to wood ash addition.

A precipitate was observed in Treatments 1 (control) and 8 (Biogrow™ only); the only two treatments that did not receive wood ash. Addition of wood ash appeared to eliminate the formation of the yellow/white precipitate that formed following evaporative loss around the bottom and up the sides of the pots. The precipitate was collected from the control pots and re-dissolved in 500 mL of distilled water. The sample was then analyzed for routine water quality parameters and metal content. The results of the analysis are presented in Table 8.

TABLE 8
Analysis of re-hydrated precipitate

| Analyte | Units | Results |
|---|---|---|
| pH | | 4.30 |
| Electrical Conductivity | uS/cm | 1790 |
| Calcium | mg/L | 372 |
| Magnesium | mg/L | 6.14 |
| Sodium | mg/L | 8.05 |
| Potassium | mg/L | 11.9 |
| Sulphate | mg/L | 1070 |
| Nitrate and nitrite | mg/L | <0.05 |
| Chloride | mg/L | 10.1 |
| Iron | mg/L | 0.17 |
| Manganese | mg/L | 0.036 |
| Total dissolved solids | mg/L | 1150 |
| Hardness (as CaC03) | mg/L | 954 |
| Metal Scan | | |
| Calcium | mg/L | 461 |
| Iron | mg/L | 1.9 |
| Magnesium | mg/L | 5.7 |
| Manganese | mg/L | 0.040 |
| Potassium | mg/L | 11.4 |
| Silicon | mg/L | 19.1 |
| Sodium | mg/L | 8.2 |
| Sulphur | mg/L | 404 |
| Aluminum | mg/L | 28.1 |
| Antimony | mg/L | <0.0004 |
| Arsenic | mg/L | <0.0004 |
| Barium | mg/L | 0.035 |
| Beryllium | mg/L | <0.0002 |
| Bismuth | mg/L | <0.001 |
| Boron | mg/L | 0.040 |
| Cadmium | mg/L | 0.00116 |
| Chromium | mg/L | 0.0171 |
| Cobalt | mg/L | 0.0242 |
| Copper | mg/L | 1.34 |
| Lead | mg/L | 0.0094 |
| Lithium | mg/L | 0.007 |
| Molybdenum | mg/L | <0.002 |
| Nickel | mg/L | 1.74 |
| Selenium | mg/L | 0.0019 |
| Silver | mg/L | <0.0002 |
| Strontium | mg/L | 1.15 |
| Thallium | mg/L | 0.00052 |
| Tin | mg/L | <0.002 |
| Titanium | mg/L | 0.0333 |
| Uranium | mg/L | 0.0012 |
| Vanadium | mg/L | 0.0007 |
| Zinc | mg/L | 0.215 |
| Zirconium | mg/L | <0.002 |

The pH of the solution is very low and the salt content (E.C.) is very high. The results indicate that the precipitate is predominantly calcium sulphate. Elevated levels of aluminum, copper, nickel, and strontium are present. This indicates that these elements are in soluble form in the unamended mine tailings. Observational evidence indicates that the addition of wood ash prevents the leaching of salts from the mine tailings. It is likely that the pH increase associated with the addition of wood ash is responsible for the reduction in solubility of these elements. The numerical extent to which wood ash reduces the leaching of the metal contaminants will be determined with further research.

Amendment of mine tailings with wood ash resulted in improved germination, plant height, and biomass production in crested wheatgrass and penncross bentgrass compared to unamended controls. Tailings receiving Biogrow™ produce superior vegetative growth and biomass production over all other treatment combinations but pH remains sub-optimum. Preliminary results indicate that a 1% ash amendment coupled with Biogrow™ application provides a balance between superior vegetation establishment and favorable pH change. This is vital in the sustainment of vegetation over time and in the immobilization of heavy metals within the soil.

1. A method of sustaining plant growth in toxic substrates polluted with heavy metal elements, characterized in that it comprises amendment of the toxic substrates with an organo-zeolitic mixture.

2. The method of claim 1, wherein the heavy metal element is Zinc, Copper, Lead, Cadmium, Arsenic, Mercury.

3. The method of claim 1 or 2, wherein the organo-zeolitic compound comprises the zeolite mineral Ca—K clinoptilolite and animal waste.

4. The method of claim 3, wherein the animal waste comprises chicken manure.

5. The method of claim 3 or 4, wherein the organo-zeolitic compound is prepared by composting animal waste with crushed zeolitic tuff.

6. The method of claim 5, wherein the ratio by volume of tuff to animal waste is roughly 1:2.

7. The method of claim 5 or 6, wherein a source of carbon is mixed with zeolitic tuff and animal waste.

8. The method of claim 7, wherein said source of carbon comprises choppen straw.

9. The method of any one of claims 1 to 7, wherein said organo-zeolitic compound is added to said polluted substrates between 10% and 65%.

10. Use of the method defined in any of claims 1 to 9 to sustain growth of wheat, barley, oats and grasses.

11. Use of the method defined in any of claims 1 to 9 to sustain growth of metallophyte plants, with metal-containing metallophyte plant tissues being collected and removed at appropriate intervals.

12. Use of the method defined in claim 11, wherein heavy metal cations remaining in the plant ash are exchanged into zeolitic tuff to be added to a cement or equivalent.

13. The addition of excess unammoniated zeolitite, 10-225 vol % increased the growth enhancement factor with the zeolite bio-fertilizer in the original compositonal form, i.e., substrate containing 16-17 vol % of the organo-zeolitic mixture.

14. Cut-off limits for the amount of excess unammoniated zeolitite to produce maximum growth can be specified.

15. These limits vary according to plant density, plant species, metal contaminant species, metal element concentration, soil physical and chemical properties.

16. By analysis of the parameters given in claim 15 it is possible to formulate the amendment to achieve either maximum shoot or root growth on a specific waste site containing heavy metal residue.

17. By achieving maximum root density, soil retention will be maximized. In this way, heavy metal pollutants will remain in situ and protected from erosional forces that cause transportation.

18. The invention alters the pH content in highly acidic soils, permitting vegetation to grow.

19. The bio-fertilizer can be used to beneficiate and fertilize non-toxic soils.

20. The ratios of animal waste to zeolite were tested, from 49:1 to 2:1 (w/w), and the ratio range of 19:1 to 2:1 (w/w) was discovered to be the most efficient, with the specific ratio of 9:1 (w/w) being the most efficient.

21. The method of claim 20 where the animal waste is chicken manure, but not excluding others.

22. We discovered that the addition of 1% wood ash eliminated leaching of the subsurface contaminants.
